(19) United States
(12) Patent Application Publication
(10) Pub. No.: US 2026/0138854 A1
(43) Pub. Date: May 21, 2026

(54) CRANE AND METHOD

(71) Applicant: Liebherr-Werk Nenzing GmbH, Nenzing (AT)

(72) Inventors: Richard TORGHELE, Bartholomaeberg (AT); Robert BARGEHR, Buers (AT)

(21) Appl. No.: 19/397,317

(22) Filed: Nov. 21, 2025

(30) Foreign Application Priority Data
Nov. 21, 2024 (DE) 10 2024 134 316.8

(51) Int. Cl. B66C 23/06; B66C 23/04; B66C 23/36

(52) U.S. Cl. CPC B66C 23/06; B66C 23/04; B66C 23/36; B66C 2700/0357

(57) ABSTRACT

The present disclosure relates to a crane, for example a mobile crane, having a main boom and a luffing jib pivotably articulated to the main boom, a retaining stay extending between the main boom and the luffing jib, the retaining stay having a lifting element whose length can be varied and being thereby variable in its length.

### CROSS REFERENCE TO RELATED APPLICATIONS

The present application claims priority to German Patent Application No. 10 2024 134 316.8 filed on Nov. 21, 2024. The entire contents of the above-listed application are hereby incorporated by reference for all purposes.

### TECHNICAL FIELD

The present disclosure relates to a crane, for example a mobile crane, having a main boom and a luffing jib pivotably articulated to the main boom, a retaining stay extending between the main boom and the luffing jib.

### BACKGROUND

It is known that, for example, particularly in inner-city areas, space conditions are often limited for erecting a crane, such as a crawler crane, on a construction site and positioning it for operation. A typical erection of a crane and a typical parking position of a conventional crane, such as the jackknife position of the crane's boom equipment, are often not possible under such limited space conditions.

### SUMMARY

It is therefore often necessary that the luffing jib of the crane, in the installed state, can be placed completely against the main boom of the crane, whereby the crane has a folding function. For example, with the main boom erected, the luffing jib is placed daily into the vertical parking position by lowering, in order to be able to park the crane in a space-saving manner overnight, for example.

It is known that for this purpose a cable hoist with multiple reeving can be installed in the retaining stay between the main boom and the luffing jib, which enables complete lowering of the luffing jib into the vertical position. For this a special main boom head is necessary that supports this folding mechanism.

A conventional crane can therefore be converted into a crane with the described folding function only by elaborate modification and/or a crane with the described folding function has a more complicated construction than a conventional crane.

Against this background, the object underlying the present disclosure is to improve a crane as described above, in particular with regard to simple construction and/or conversion.

This object is achieved by the subject matter with the features described herein.

Accordingly, it is provided according to the disclosure that the retaining stay has a lifting element whose length can be varied and is thereby variable in its length.

Optionally, the retaining stay has a lifting element and a main strand, e.g. one or more steel ropes, steel stay rods and/or CFRP stay rods, the lifting element and the main strand being connected via an adapter.

The luffing jib can also be referred to as a luffing needle.

The main boom and the luffing jib are optionally components of boom equipment.

The crane is optionally a mobile crane, for example a crawler crane.

Optionally, the crane has an adjustable retaining stay for the luffing mechanism of the luffing jib of the crane.

The crane may have a plurality of lifting elements, for example arranged in parallel.

Optionally, it is provided that the lifting element is a hydraulic lifting element, for example a hydraulic cylinder, or an electric lifting element, for example a linear actuator.

Optionally, the lifting element is a hydraulically and/or electrically operated lifting element.

Optionally, it is provided that the retaining stay can be extended such that the luffing jib can be pivoted relative to the main boom in such a way that the luffing jib abuts the main boom.

In other words, it is optionally provided that the main boom and the luffing jib can be folded together.

Optionally, it is provided that the retaining stay is fastened with one end to a lower or upper region of the main boom when the main boom is in a vertical position, the lifting element being arranged at this end of the retaining stay.

Alternatively, the lifting element can also be arranged or mounted, for example, at the boom head, that is, in the upper region of the main boom.

Optionally, it is provided that the retaining stay has locking means designed to lock the lifting element, for example in a retracted position of the lifting element, for example such that the lifting element cannot be extended.

Optionally, it is provided that the locking means comprise or are constituted by a hydraulic element, for example a hydraulic cylinder, or an electrically operated element, for example a linear actuator.

Optionally, it is provided that the lifting element has a housing and a piston rod that can be extended out of the housing and retracted into the housing.

The adapter may be part of the piston rod.

Optionally, it is provided that one or more locking lugs each having an opening are arranged on the housing, the piston rod having an opening, a locking element, for example a locking bolt, being provided, the locking element being able to be passed through the opening of the locking lug or the openings of the locking lugs and the opening of the piston rod when the openings are aligned, in order to lock the lifting element in a retracted position, the locking means comprising the locking lug or locking lugs and the locking element.

Optionally, the adapter of the piston rod has the opening.

Optionally, it is provided that the locking means comprise monitoring means, for example an electromechanical switch or a proximity switch, by means of which the position of the locking means, for example of the locking element, can be determined.

The disclosure also relates to a method for operating a crane according to the disclosure, comprising the steps of:
shortening the retaining stay by shortening the lifting element, wherein the luffing jib is swung out relative to the main boom by an initial opening angle; and
locking the lifting element.

Optionally, it is provided that first the main boom and the luffing jib lying against it are raised from a horizontal position into a vertical position.

Optionally, it is provided that the crane is brought into a parking position by first bringing the crane into a state in which the main boom is in a vertical position and the luffing jib is pivoted relative to the main boom by the initial opening angle, whereupon unlocking of the lifting element or the lifting elements and/or lengthening of the retaining stay by lengthening the lifting element or the lifting elements takes place, the luffing jib being pivoted in by the initial opening angle relative to the main boom such that the luffing jib abuts the main boom.

Optionally, it is provided that subsequently the main boom and the luffing jib lying against it are laid down from the vertical position into a horizontal position.

The disclosure also relates to a method of retrofitting a crane with a main boom and a luffing jib pivotably articulated to the main boom, a retaining stay extending between the main boom and the luffing jib, characterized in that one or more lifting elements variable in their length are introduced into the retaining stay, so that the crane becomes a crane according to the disclosure.

Optionally, a conventional crane can be retrofitted in such a way that the retaining stay has one or more retaining elements variable in their length and is thereby variable in its length.

Optionally, retention of the entire existing boom equipment of the crane to be retrofitted can be effected. Optionally, a crane according to the disclosure has a base machine identical to that of a conventional crane.

Optionally, when retrofitting a conventional crane, all previous functions remain available, such as hoisting operation with the main boom, two-hook operation, runner operation, and use of the complete needle portfolio. Optionally, a crane according to the disclosure that is newly manufactured, i.e. not formed from a conventional crane by retrofitting, also has these functions.

Optionally, lengthening of the retaining stay can be made possible by means of one or two lifting elements that are hydraulically and/or electrically operated. Optionally, it is provided that the complete, existing boom equipment and thus the existing base machine of a conventional crane can continue to be used. The base machine may thus remain unchanged. Optionally, all previous functions remain, such as hoisting operation with the main boom, two-hook operation, runner operation, and use of the complete needle portfolio. The folding function can optionally be retrofitted to today's standard.

Optionally, the luffing jib can be connected to the main boom when the luffing jib lies against the main boom.

At this point it is noted that the terms “a” and “an” do not necessarily refer to exactly one of the elements, even though this represents one possible embodiment, but can also designate a plurality of the elements. Likewise, the use of the plural also includes the presence of the relevant element in the singular, and conversely the singular also encompasses several of the relevant elements. Furthermore, all features of the disclosure described herein can be combined with one another as desired or claimed in isolation from one another.

### BRIEF DESCRIPTION OF THE FIGURES

Further advantages, features and effects of the present disclosure emerge from the following description of embodiments with reference to the figures, in which identical or similar components are designated by the same reference numerals. In the figures:

FIG. 1: a side view of an embodiment of a crane according to the disclosure.

FIG. 2: a side view of an embodiment of a crane according to the disclosure.

FIG. 3: a detail of the side view of the embodiment of a crane according to the disclosure from FIG. 2.

FIG. 4: a side view of an embodiment of a crane according to the disclosure.

FIG. 5: a detail of the side view of the embodiment of a crane according to the disclosure from FIG. 4.

FIG. 6: a side view of an embodiment of a crane according to the disclosure.

FIG. 7: a perspective view of a detail of an embodiment of a crane according to the disclosure.

FIG. 8: a side view of a detail of an embodiment of a crane according to the disclosure.

### DETAILED DESCRIPTION

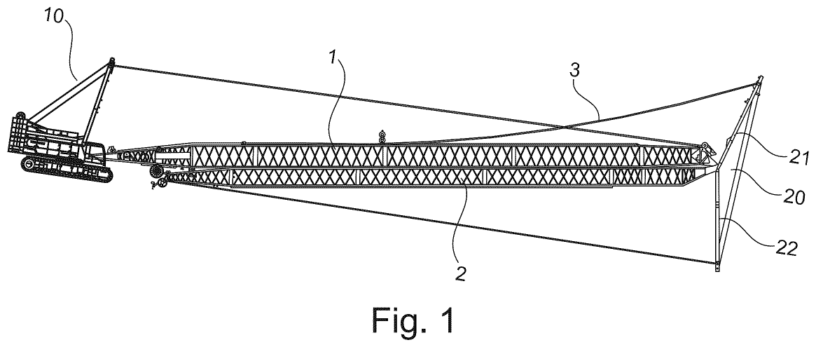

In FIG. 1, a crane 10 in the form of a crawler crane is shown with a main boom 1 and a luffing jib 2. The luffing jib 2 is pivotably articulated to the main boom 1. A retaining stay 3 extends between the main boom 1 and the luffing jib 2. The main boom 1 and the luffing jib 2 are the main components of the boom equipment of the crane 10.

The lifting element 30 is connected via an adapter to a main strand—e.g. one or more steel ropes, steel stay rods and/or CFRP stay rods—of the retaining stay 3.

The luffing jib 2 has a luffing mechanism 20 with a lower A-frame 21 and an upper A-frame 22. By means of the luffing mechanism 20, the entire luffing jib 2 can be pivoted or luffed. The luffing mechanism 20 can also be referred to as a needle retraction mechanism.

The retaining stay 3 is fastened to a lower region of the main boom 1 and to a free end of the lower A-frame 21.

In FIG. 1, the assembled crane 10 is shown in a parking position, the boom equipment being laid down on the ground and in a horizontal position. The luffing jib 2 lies completely against the main boom 1. The main boom 1 and the luffing jib 2 are thus folded together.

The position of the crane 10 shown in FIG. 1 occurs after assembly of the crane 10 or after complete laying down of the boom equipment. In order to be able to assume this position, the retaining stay 3 is extendable. The extension can be made possible by means of one or two lifting elements operated hydraulically and/or electrically in the retaining stay 3. In the embodiment, the retaining stay 3 has exactly one lifting element. The crane 10 can have a plurality of lifting elements, e.g. two lifting elements arranged in parallel. In the embodiment, the lifting element is a hydraulic cylinder. In the position of the crane 10 or the boom equipment shown in FIG. 1, the required extension of the retaining stay 3 is at a maximum. The lifting element is fully extended.

In the parking position of the crane 10 shown in FIG. 1, the retaining stay 3 can be relieved and the lifting element 30 can be laid down on the main boom 1. The lower A-frame 21 is secured with a chain in this case.

The lifting element 30 can also be decoupled from the adapter and retracted. The adapter can be secured.

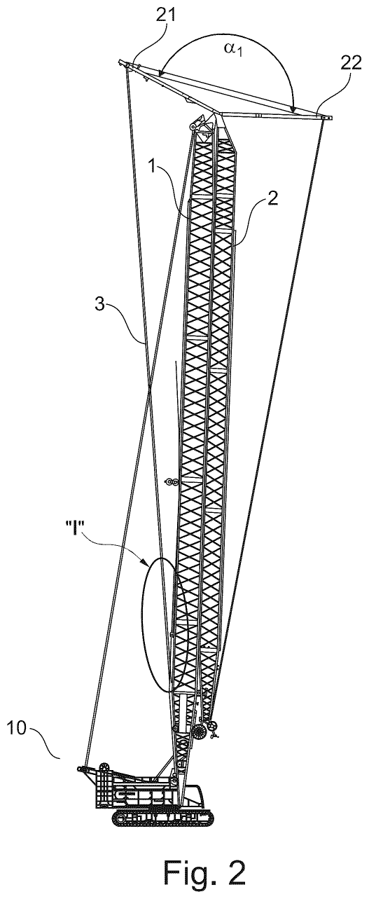

In FIG. 2, the crane 10 is shown with the boom equipment erected, the main boom 1 and the luffing jib 2 standing vertically or being vertically aligned and folded together. The position shown in FIG. 2 occurs after the boom equipment has been raised, or before the boom equipment is laid down into its horizontal parking position after the end of work. In the position of the crane 10 or the boom equipment shown in FIG. 2, the required extension of the retaining stay 3 is at a maximum. The lifting element or the lifting elements are fully extended.

The A-frames 21 and 22 assume an angle of α1 depending on the boom configuration.

The required length of the lifting element 30 varies depending on the boom configuration.

In its vertical position, the main boom 1 assumes an angle between 88° and 90° relative to the ground.

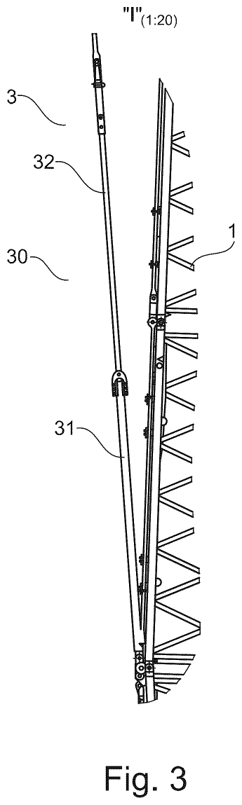

In FIG. 2, detail I is encircled, which is shown enlarged in FIG. 3.

In FIG. 3, the lifting element 30 of the retaining stay 3 is shown in an extended position, the piston rod 32 of the lifting element 30 being fully extended out of the housing 31 of the lifting element 30. The lifting element 30 is a hydraulic cylinder. The housing 31 is fastened to the main boom 1 and the piston rod 32 is fastened, via an adapter of the piston rod 32, to a main strand of the retaining stay 3 leading to the luffing jib 2, e.g. one or more steel ropes, steel stay rods and/or CFRP stay rods.

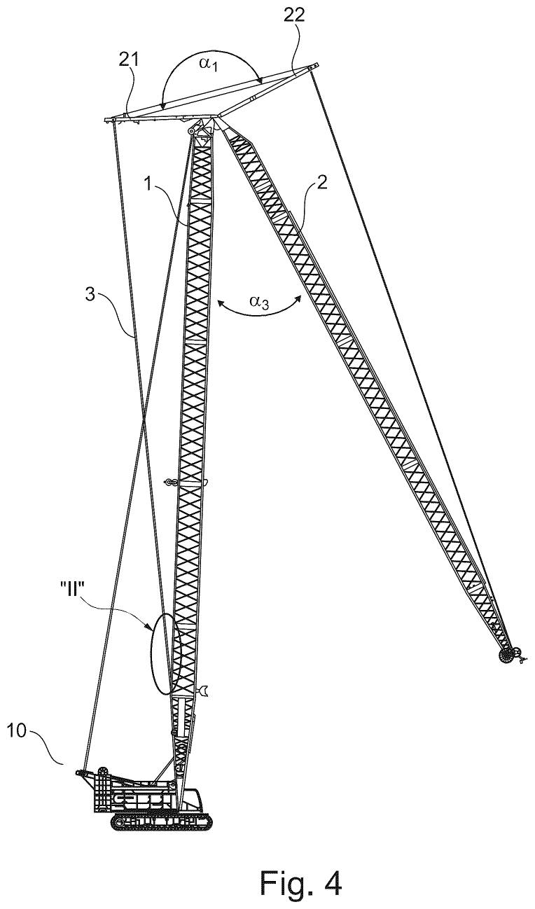

By means of the lifting element 30 integrated into the retaining stay 3, the retaining stay 3 is shortened to its working length, the luffing jib 2 being pivoted relative to the main boom 1 until the luffing jib 2 assumes an initial opening angle of α₃ relative to the main boom 1. The luffing jib 2 then stands at α₃ and is ready for further swinging out, as is apparent from FIG. 4. The angle α₁ between the A-frames 21 and 22 does not change in the process.

In FIG. 4, the crane is shown in a start position for further swinging out of the luffing jib 2.

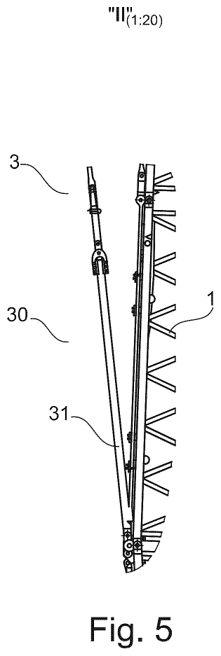

In FIG. 4, detail II is encircled, which is shown enlarged in FIG. 5.

In FIG. 5, the lifting element 30 of the retaining stay 3 is shown in a retracted position, the piston rod 32 of the lifting element 30 being fully retracted into the housing 31 of the lifting element 30.

In this position of the lifting element 30, the retaining stay 3 has reached its working length. The lifting element 30 is fully retracted. In its retracted position, the lifting element 30 can be locked by locking means. The required extension or shortening of the retaining stay 3 results from the vertical position of the luffing jib 2 up to the initial opening angle of α₃=30°.

The luffing jib 2 is then swung further by its luffing mechanism 20 as before. During further swinging out of the luffing jib 2, the angle α₁ between the A-frames 21 and 22 will decrease to a maximum of α₂. During swinging in of the luffing jib 2, the angle α₂ between the A-frames 21 and 22 will increase to a maximum of α₁. The angle between the lower A-frame 21 and the main boom 1 does not change in the process.

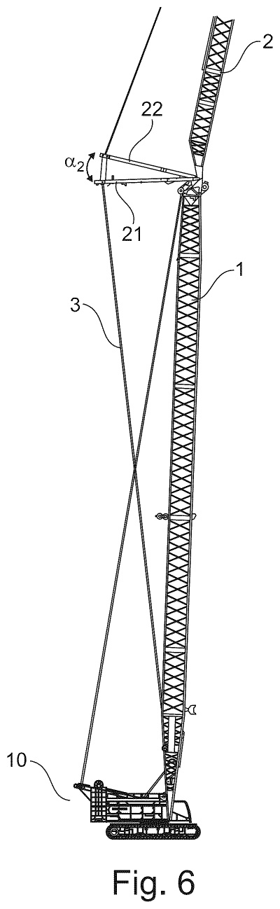

In FIG. 6, the luffing jib 2 swung out to the maximum is shown with the angle α₂ between the A-frames 21 and 22.

FIG. 6 shows the crane 10 in a working position, the luffing jib 2 being swung out here by way of example to the maximum angle, the angle between the A-frames 21 and 22 being α₂. The complete raising process is completed and the crane 10 is in a ready-for-operation state.

In the position shown in FIG. 6, the retaining stay 3 has its working length that cannot be changed due to its locking. The lifting element 30 is fully retracted and locked.

The sequence of FIGS. 1 to 6 thus shows a raising process of the boom equipment and the sequence of FIGS. 6 to 1 shows a laying-down process of the boom equipment.

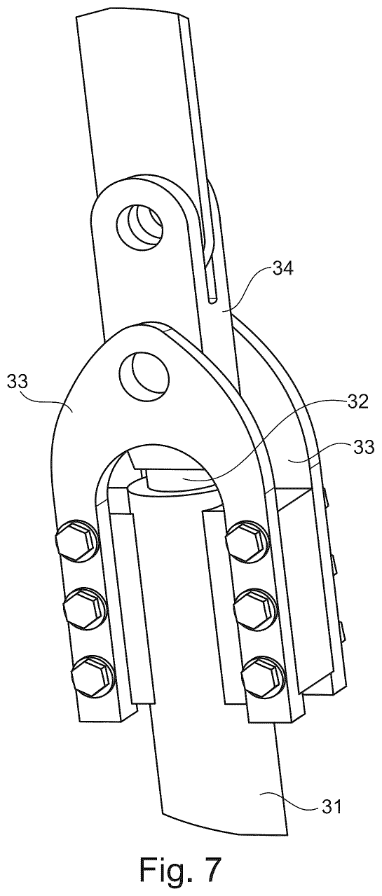

In FIG. 7, parts of the locking means are shown, by means of which the lifting element 30 can be locked in its retracted position, in the form of two locking lugs 33 arranged—screwed on in this example—on the housing 31 of the lifting element 30. The locking lugs 33 can also be welded. The locking lugs 33 are fastened to an end of the housing 31 pointing toward the main strand of the retaining stay 3.

The piston rod 32 is fully retracted in FIG. 7 and has an adapter with a coupling lug 34 by which the piston rod 32 is connected to the main strand of the retaining stay 30 leading to the luffing jib 2.

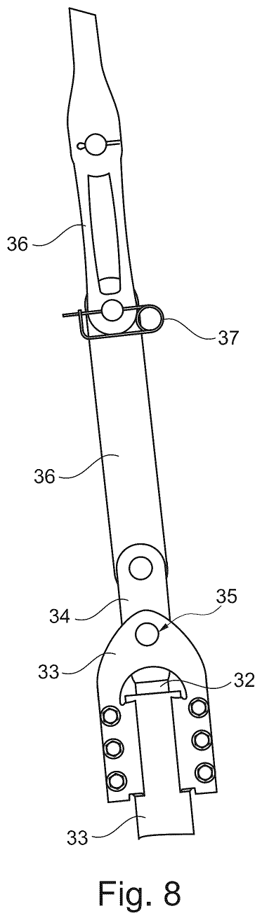

An opening is present in each of the locking lugs 33 and the coupling lug 34. When these openings are in alignment—i.e. when the piston rod 32 is fully retracted into the housing 31—a locking bolt 35 can be passed through these openings, as is apparent from FIG. 8.

In other words, FIGS. 7 and 8 show the connection of the main strand of the retaining stay 3 to the lifting element 30 in its locked position. At least one locking lug 33 is attached to the housing 31 of the lifting element 30, enabling locking of the piston rod 32 against unintentional extension.

In FIG. 8, further lugs 36 of the adapter between the main strand of the retaining stay 3 and the lifting element 30 are shown. The connection of these lugs 36 is secured with a cotter pin 37.

The position of the locking bolt 35 is monitored by monitoring means. By means of the monitoring means, it can be determined whether the lock is open or closed, i.e. whether the locking bolt 35 passes through all the openings or not.

If the piston rod 31 of the lifting element 30 is not locked with the locking bolt 35, i.e. in the open state, crane hoisting operation is not enabled. The crane remains in the operating state “assembly” until confirmation of a correct lock is present. In the operating state “crane operation” or “crane hoisting operation,” the locking bolt 35 cannot be unlocked. For unlocking, the operating state must first be switched back to “assembly.” Monitoring can be carried out with an electric toggle switch and/or proximity initiators as monitoring means. This arrangement ensures that, in crane hoisting operation, the retaining stay 3 cannot be varied in length.

1. A crane having a main boom and a luffing jib pivotably articulated to the main boom, wherein a retaining stay extends between the main boom and the luffing jib, and wherein the retaining stay comprises a lifting element whose length can be varied and is thereby variable in its length.

2. The crane according to claim 1, wherein the lifting element is a hydraulic lifting element or an electric lifting element.

3. The crane according to claim 1, wherein the retaining stay can be extended such that the luffing jib can be pivoted relative to the main boom in such a way that the luffing jib abuts the main boom.

4. The crane according to claim 1, wherein the retaining stay is fastened with one end to a lower or upper region of the main boom in a vertical position of the main boom, the lifting element being arranged at this end of the retaining stay.

5. The crane according to claim 1, wherein the retaining stay has locking means which are designed to lock the lifting element.

6. The crane according to claim 5, wherein the locking means comprise a hydraulic element or an electrically operated element.

7. The crane according to claim 1, wherein the lifting element has a housing and a piston rod that can be extended out of the housing and retracted into the housing.

8. The crane according to claim 7, wherein one or more locking lugs each having an opening are arranged on the housing, wherein the piston rod has an opening, and wherein a locking element is configured to pass through the opening of the one or more locking lugs and the opening of the piston rod when the openings are aligned, in order to lock the lifting element in a retracted position.

9. The crane according to claim 8, wherein the locking means comprise monitoring means by means of which a position of the locking means can be determined.

10. A method for operating the crane according to claim 1, comprising the steps of:
shortening the retaining stay by shortening the lifting element, wherein the luffing jib is swung out relative to the main boom by an initial opening angle; and
locking the lifting element.

11. The method according to claim 10, wherein first the main boom and the luffing jib lying against it are raised from a horizontal position into a vertical position.

12. The method according to claim 10, wherein the crane is brought into a parking position by first bringing the crane into a state in which the main boom is in a vertical position and the luffing jib is pivoted relative to the main boom by the initial opening angle, whereupon unlocking of the lifting element and/or lengthening of the retaining stay by lengthening the lifting element takes place, the luffing jib being pivoted in by the initial opening angle relative to the main boom such that the luffing jib abuts the main boom.

13. The method according to claim 12, wherein subsequently the main boom and the luffing jib lying against it are laid down from the vertical position into a horizontal position.

14. The method for retrofitting a crane with a main boom and a luffing jib pivotably articulated to the main boom, a retaining stay extending between the main boom and the luffing jib, wherein one or more lifting elements variable in their length are introduced into the retaining stay, so that the crane becomes the crane according to claim 1.

15. The crane according to claim 1, wherein the crane is a mobile crane.

16. The crane according to claim 2, wherein the hydraulic lifting element comprises a hydraulic cylinder and the electric lifting element comprises a linear actuator.

17. The crane according to claim 5, wherein the locking means are designed to lock the lifting element in a retracted position of the lifting element such that the lifting element cannot be extended.

18. The crane according to claim 6, wherein the hydraulic element comprises a hydraulic cylinder and the electrically operated element comprises a linear actuator.

19. The crane according to claim 8, wherein the locking element comprises a locking bolt.

20. The crane according to claim 9, wherein the monitoring means comprise an electromechanical switch or a proximity switch.
